(19) United States
(12) Patent Application Publication
(10) Pub. No.: US 2026/0267875 A1
(43) Pub. Date: Sep. 10, 2026

(54) Method for Apparatus for Storing and Providing Georeferenced Vehicle Data

(71) Applicant: Bayerische Motoren Werke Aktiengesellschaft, Muenchen (DE)

(72) Inventor: Sebastian Kirchner, Muenchen (DE)

(21) Appl. No.: 18/875,646

(22) PCT Filed: Apr. 20, 2023
(86) PCT No.: PCT/EP2023/060225

§ 371 Date: Dec. 16, 2024

(30) Foreign Application Priority Data
Jul. 15, 2022 (DE) 10 2022 117 704.1

(51) Int. Cl. G06F 16/27; G06F 16/22; G06F 16/29; G06N 20/00

(52) U.S. Cl. CPC G06F 16/278; G06F 16/2246; G06F 16/29; G06N 20/00

(57) ABSTRACT

A method includes receiving georeferenced vehicle data using memory of a distributed system, and determining a subset of the georeferenced vehicle data using a first computing unit of the distributed system, the subset including time information and location information. The method includes ascertaining a partitioning scheme comprising time partitions and location partitions as a function of time information and location information pertaining to the subset. A first computing unit trains a machine-learning method for predicting a zoom level of the item of location information pertaining to the georeferenced vehicle data with the ascertained partitioning scheme and with the subset of the georeferenced vehicle data. Computing units of the system partition and store data pertaining to the georeferenced vehicle data using the trained method. The method includes receiving a request message requesting georeferenced vehicle data including time information and location information; and providing the requested data using the stored partitioned data.

The present application is the U.S. national phase of PCT Application PCT/EP2023/060225 filed on Apr. 20, 2023, which claims priority of German patent application No. 10 2022 117 704.1 filed on Jul. 15, 2022, which is incorporated herein by reference in its entirety.

### TECHNICAL FIELD

The disclosure relates to storing and providing georeferenced vehicle data, and methods, computer-readable media, and distributed systems therefor.

### BACKGROUND

Present-day vehicles are able to communicate a multitude of vehicle data to a backend server. The vehicle data are usually big-data datasets which may be many gigabytes in size. Partitioning methods for partitioning large datasets, in order to make interrogations of data possible more efficiently, are known from the prior art. Known software solutions are, for instance, Apache Spark or GeoSpark. However, the known software solutions have the disadvantage that data have to be distributed between computing units of a distributed system before the data can be processed in a computing unit of the distributed system. Moreover, the known methods have the disadvantage that each computing unit creates its own partitioning scheme, which can lead to inefficient filing and inefficient interrogation of the filed data.

There is a need to improve storage and provision of georeferenced vehicle data. There is furthermore a need to make possible an error-tolerant storage of georeferenced vehicle data that efficiently makes error-free interrogations of the georeferenced vehicle data possible.

### SUMMARY

The above-stated needs, as well as others, are addressed by features disclosed herein.

A first aspect includes a method for storing and providing georeferenced vehicle data. The method may be a computer-implemented method. The georeferenced vehicle data are preferably stored and provided on a distributed system. The distributed system may be, for instance, a cloud computing system, a grid computing system, or a cluster system.

The method includes receiving the georeferenced vehicle data by means of a data memory of a distributed system. For instance, the georeferenced data may be received from a plurality of vehicles of a vehicle fleet. The method further includes determining a subset of the georeferenced vehicle data by means of a first computing unit of the distributed system, the subset comprising data with an item of time information and with an item of location information pertaining to the georeferenced vehicle data, and ascertaining, by means of the first computing unit of the distributed system, a partitioning scheme comprising time partitions and location partitions as function of time information and location information pertaining to the subset of the georeferenced vehicle data. The method trains, by means of the first computing unit of the distributed system, a machine-learning method for predicting a zoom level of the item of location information pertaining to the georeferenced vehicle data with the ascertained partitioning scheme and with the subset of the georeferenced vehicle data, and partitions, by means of a plurality of computing units of the distributed system, data pertaining to the received georeferenced vehicle data by using the trained machine-learning method. The zoom level may include a subdivision of a world map into predefined areas of a given size. The partitioned data pertaining to the received georeferenced vehicle data are stored in the data memory of the distributed system by means of the plurality of computing units of the distributed system. Lastly, the method includes receiving a request message requesting georeferenced vehicle data, the request message including an item of time information and an item of location information, and providing the georeferenced vehicle data pertaining to the request message, the georeferenced vehicle data being provided by using the stored, partitioned data.

The method can advantageously store and interrogate georeferenced vehicle data efficiently.

According to an exemplary configuration, a size of the subset of the georeferenced data can be chosen in such a way that for the subset of the georeferenced data the partitioning scheme can be ascertained by the first computing unit of the distributed system, and/or the machine-learning method can be trained by the first computing unit of the distributed system. By this means, the machine-learning method can be trained with a partitioning scheme that is complete for the subset.

In some embodiments, the subset of the georeferenced data can be determined as a function of a temporal data progression, the temporal data progression preferably being representative of a day, a week and/or a month, and/or the temporal data progression preferably being representative of a difference between weekdays—days Monday to Friday—and weekend—days Saturday and Sunday. By this means, a representative subset of the georeferenced data can be ascertained efficiently.

In some embodiments, the partitioning scheme can be ascertained using quadtrees. By this means, the partitioning scheme can be computed efficiently in a single computing unit of the distributed system.

According to another configuration, the partitioning scheme for an item of time information and an item of location information pertaining to a dataset of the subset of the georeferenced data a time partition and a location partition can be ascertained, the location partition preferably being uniquely determined by a geohash, and the geohash preferably specifying a zoom level of the location partition. By this means, a partitioning scheme can be specified, with which the georeferenced vehicle data can be stored and interrogated efficiently.

According to some embodiments, the training of the machine-learning method may include ascertaining hyperparameters of the machine-learning method by means of cross-validation. By this means, the training of the machine-learning method can be improved efficiently.

According to some embodiments, the method may further include distributing the trained machine-learning method from the first computing unit of the distributed system to the plurality of computing units of the distributed system. By this means, the trained machine-learning method can be used in the plurality of computing units in order to divide up the georeferenced data into partitions and to store them.

According to some configurations, the partitioning of the data pertaining to the received georeferenced vehicle data by means of the plurality of computing units of the distributed system by using the trained machine-learning method may include determining a time partition of the partitioning scheme as a function of an item of time information pertaining to the dataset, predicting, by means of one computing unit of the plurality of computing units, a zoom level of a location partition as a function of an item of location information pertaining to a dataset of the received georeferenced vehicle data using the trained machine-learning method, determining, by means of the computing unit of the plurality of computing units, geohash by using the item of location information and the predicted zoom level of the location partition, and determining a location partition of the partitioning scheme as a function of the geohash. By this means, datasets of the georeferenced data can be divided up efficiently into partitions with differing zoom levels. Moreover, the datasets of the georeferenced vehicle data can be filed in error-tolerant manner in the partitions with differing zoom levels.

According to some embodiments, the storing, by means of the plurality of computing units of the distributed system, of the partitioned data pertaining to the received georeferenced vehicle data in the data memory of the distributed system may include storing the dataset of the received georeferenced vehicle data in the determined time partition and location partition. By this means, the georeferenced vehicle data can be stored efficiently.

According to some embodiments, the providing of the georeferenced vehicle data pertaining to the request partitions as a function of the item of time information pertaining to the request message, ascertaining geohashes of all the zoom levels as a function of the item of location information pertaining to the request message, determining location partitions of the ascertained geohashes, interrogating the georeferenced vehicle data pertaining to the item of time information and to the item of location information pertaining to the request message in the determined one or more time partitions and in the determined location partitions, and providing the interrogated georeferenced vehicle data in response to the request message. By this means, a request for vehicle data can be implemented efficiently. By virtue of the ascertaining of geohashes of all the relevant zoom levels of the item of location information, georeferenced vehicle data, for the trained machine-learning method an incorrect zoom level predicted, can be correctly discovered and interrogated in the course of the request. In other words, the request can provide the correct georeferenced vehicle data even if they have been stored in an incorrect partition.

A further aspect is a computer-readable medium for storing and providing georeferenced vehicle data, the computer-readable medium including instructions that, when executed in one or more computing units of a distributed system, execute the method described above.

A further aspect is a distributed system for storing and providing georeferenced vehicle data, the distributed system being designed to execute the method described above.

Further features arise from the claims, from the FIGURE and from the description of the FIGURE. All the features description, and also the features and combinations of features mentioned below in the description of the FIGURE, and/or shown in the FIGURE alone, are capable of being used not only in the respectively specified combination but also in other combinations or on their own.

The above-described features and advantages, as well as others, will become more readily apparent to those of ordinary skill in the art by reference to the following detailed description and accompanying drawings.

### BRIEF DESCRIPTION OF THE DRAWING

FIG. 1 shows schematically an exemplary method for storing and interrogating georeferenced vehicle data in a distributed system.

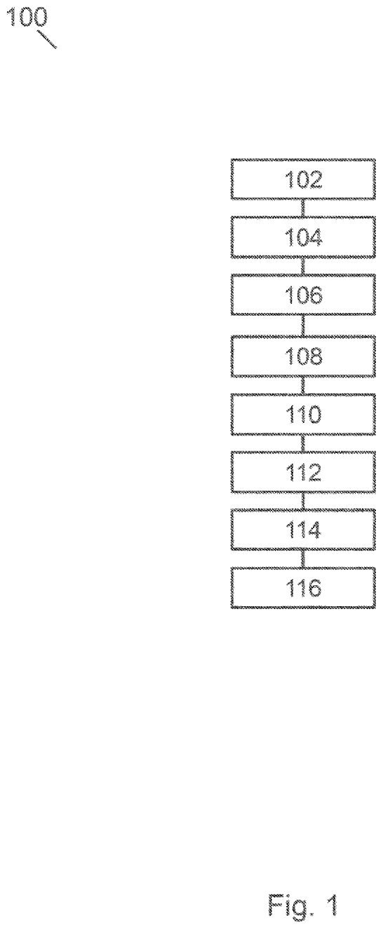

In detail, FIG. 1 shows an exemplary method 100 for storing and interrogating georeferenced vehicle data in a distributed system. Vehicle data frequently include time data and georeferenced data. For instance, georeferenced data may comprise latitudinal and longitudinal coordinates of a position of a vehicle. In addition, the vehicle data may include further application-specific data. The vehicle data—in particular, the georeferenced vehicle data—can be utilized for location-based services, map-based functions, and/or driver-assistance systems of a vehicle. The georeferenced vehicle data may be big-data datasets having several hundred gigabytes to a few terabytes of data. The storing of the georeferenced vehicle data can be undertaken by means of partitioning by time and location. The partitioning by location can be undertaken, for instance, by using geohashes. In order to make a partitioning using geohashes possible, a world map can be subdivided into differing geometric areas, for instance rectangles or hexagons, and also into differing zoom levels. A zoom level can establish a size of a geometric area. It holds true that each geohash of a zoom level n is filled out completely by geohashes of a zoom level n+1 in the same geometric area. For the purpose of coding a geohash, combinations of one or more letters and/or one or more numbers, for instance, can be defined, in order to be able to identify the area of the geohash uniquely. The zoom level can establish a size of a partition by virtue of the size of the geometric area of the zoom level. Once the size of the partition has been established, the number of data items can be established that will be sorted into this partition from the total amount of the georeferenced vehicle data.

In order to be able to establish a number of zoom levels, preferably all the georeferenced vehicle data have to be taken into consideration. On account of the size of the dataset of the georeferenced vehicle data, only a subset of the georeferenced vehicle data can be used for a definition of the zoom levels. Furthermore, the subset of the georeferenced vehicle data may include a subset of attributes of all or some subsets of the georeferenced vehicle data. In order to make possible a distribution of the georeferenced vehicle data into partitions that is as efficient as possible, the method 100 proposes to use a machine-learning method for partitioning the georeferenced vehicle data.

In detail, the method 100 can receive 102 the georeferenced vehicle data by means of a data memory of a distributed system. The georeferenced vehicle data may be received from one vehicle or from a plurality of vehicles, for instance from a vehicle fleet or from a subset of a vehicle fleet. The method 100 can determine 104 a subset of the georeferenced vehicle data by means of a first computing unit of the distributed system. The subset may include data with an item of time information, for instance a date, and with an item of location information, for instance a position of a vehicle, pertaining to the georeferenced vehicle data. Preferably, no application-specific data are contained in the subset. As a result, a size of the georeferenced vehicle data can be decreased efficiently. The size of the subset of the georeferenced vehicle data is preferably chosen in such a way that the subset can be used on a single computer of the distributed system in order to train the machine-learning method. For instance, the size of the subset of the georeferenced vehicle data can be chosen in such a way that specifications as regards memory usage and computing time are complied with in the course of the training of the machine-learning method. The size of the subset of the georeferenced vehicle data preferably amounts to a few gigabytes of data. The subset of the georeferenced vehicle data is furthermore chosen in such a way that the distribution of the data of the subset corresponds to the distribution of all the georeferenced vehicle data with respect to the item of time information and/or the item of location information. As a result, errors when training the machine-learning method can be avoided. For instance, the subset of the georeferenced vehicle data may comprise only data relating to an item of time information and an item of location information. Application-specific data pertaining to the georeferenced vehicle data that are not relevant for the training of the machine-learning method may not be considered any further for determining the subset of the georeferenced vehicle data. In addition, only a date of an item of time information, for instance, may be used for determining the subset. A time-stamp of the item of time information may not be considered any further for determining the subset.

The method 100 can ascertain 106, by means of the first computing unit of the distributed system, a partitioning scheme comprising time partitions and location partitions as function of time information and location information pertaining to the subset of the georeferenced vehicle data. For instance, by using one or more known methods the method 100 can ascertain partitioning scheme—in particular, an optimal partitioning scheme—for the subset of the georeferenced vehicle data. A known method for computing a partitioning scheme can ascertain, for instance by using quadtrees, an optimal partitioning scheme for the subset of the georeferenced vehicle data. The ascertained partitions of the partitioning scheme can be used as labels for a multi-class classification problem that is to be solved by means of the machine-learning method.

The method 100 can train 108, by means of the first computing unit of the distributed system, a machine-learning method for predicting a zoom level of the item of location information pertaining to the georeferenced vehicle data with the ascertained partitioning scheme and with the subset of the georeferenced vehicle data. The machine-learning method may be a known machine-learning method. Various machine-learning methods can be evaluated with expert knowledge or with methods such as, for instance, cross-validation, in order to determine a suitable machine-learning method. The objective of the training of the machine-learning method is to predict a zoom level of the item of location information for each item of time information—in particular, each new date—and for each item of location information—for instance, latitudinal and longitudinal coordinates. A geohash can subsequently be ascertained for the predicted zoom level. For this purpose, the labels of the ascertained partitions can be used as output of the machine-learning method. A label may correspond to a zoom level of the item of location information. The subset of the georeferenced vehicle data may serve as input for the purpose of training the machine-learning method.

The method 100 can partition 110, by means of a plurality of computing units of the distributed system, the data pertaining to the received georeferenced vehicle data by using the trained machine-learning method. For each dataset of the received georeferenced vehicle data, the item of time information and the item of location information are utilized as input of the trained machine-learning method, in order to predict a zoom level. This is undertaken in a manner analogous to the training of the machine-learning method, as described above. By using the zoom level and the item of location information, an associated geohash can be computed. With the geohash, the location partition can be ascertained uniquely. Furthermore, the time partition can be ascertained by using the item of time information, for instance by using a time-stamp of each dataset of the georeferenced vehicle data.

The trained machine-learning method can perform a probability-based prediction of a zoom level for each datum of a dataset of the georeferenced vehicle data. This may have the consequence that the optimal zoom level for each datum is not always predicted by the machine-learning method, and the dataset of the georeferenced vehicle data is not stored in the optimal partition. By virtue of the filing of the georeferenced vehicle data in an error-tolerant filing scheme, a subsequent request for georeferenced vehicle data can be made possible in a lossless manner. An error-tolerant filing scheme can be implemented with a partitioning of the georeferenced vehicle data by using geohashes. For geohashes, it holds that a geohash of zoom level n maps to a set of geohashes of zoom level n+1. Moreover, for geohashes it holds that all the geohashes of zoom level n+1 are contained completely within the geohash of zoom level n and fill it out. In the event of an interrogation of georeferenced vehicle data partitioned with geohashes, all the relevant geohashes of all the zoom levels can be interrogated, and consequently datasets of the georeferenced vehicle data that were filed at a different zoom level can also be ascertained. A lossless interrogation of the georeferenced vehicle data is consequently possible.

The method 100 can store 112, by means of the plurality of computing units of the distributed system, the partitioned data pertaining to the received georeferenced vehicle data in the data memory of the distributed system. By using the time partition and the location partition, each dataset of the georeferenced vehicle data can be processed and stored independently by means of one computing unit from the plurality of computing units of the distributed system. An example of a filing scheme for storing the datasets pertaining to the georeferenced vehicle data may have been structured as follows:
Root Folder/
   date=2022-03-07
      geohash=g12
         all datasets dated 03.07.2022 and geohash=g12
      geohash=g1234
         all datasets dated 03.07.2022 and geohash=g1234
      geohash=f567
         all datasets dated 03.07.2022 and geohash=f567
   date=2022-03-08
      geohash=g12
         all datasets dated 03.08.2022 and geohash=g12
      geohash=g1234
         all datasets dated 03.08.2022 and geohash=g1234
      geohash=f567
         all datasets dated 03.08.2022 and geohash=f567
. . .

The method 100 can receive 114 request message requesting georeferenced vehicle data, the request message including an item of time information and an item of location information. Furthermore, the method 100 can provide 116 the georeferenced vehicle data pertaining to the request message, the georeferenced vehicle data being provided by using the stored, partitioned data. An exemplary request message includes an interrogation of all the data pertaining to the georeferenced vehicle data from a particular location as location information and from a particular time interval as time information. The particular time interval of the exemplary request message may include the days 03.07.2022 and 03.08.2022. In the exemplary filing scheme, the days of the time interval can be mapped directly onto the time information pertaining to the time partitions. The particular location of the exemplary request message may be Munich. For the particular location Munich, the method can determine the relevant geohashes for all the zoom levels. For instance, the particular location Munich may include geohash g12 for a first zoom level of the particular location and geohash g1234 for a second zoom level of the particular location. The geohashes can be mapped directly onto the partitions of the filing scheme. The outcome of the request comprises all the data pertaining to the georeferenced vehicle data that have been stored in the ascertained partitions of the filing scheme.

The machine-learning method can be retrained in the event of an amendment of a distribution of the georeferenced vehicle data. For this purpose, new training data can be ascertained as described above, and the machine-learning method can be trained with the new training data.

Advantageously, the method can efficiently ascertain a partitioning scheme for georeferenced vehicle data that makes error-tolerant storing of the georeferenced vehicle data possible.

### LIST OF REFERENCE SYMBOLS

100 method
102 receive georeferenced vehicle data
104 determine a subset of the georeferenced vehicle data
106 ascertain a partitioning scheme
108 train a machine-learning method
110 partition data pertaining to the georeferenced vehicle data
112 store the partitioned data
114 receive a request message
116 provide the georeferenced vehicle data

1.-12. (canceled)

13. A method for storing and providing georeferenced vehicle data, the method comprising:
receiving the georeferenced vehicle data using a data memory of a distributed system;
determining a subset of the georeferenced vehicle data using a first computing unit of the distributed system, the subset comprising data with an item of time information and with an item of location information pertaining to the georeferenced vehicle data;
ascertaining, using the first computing unit of the distributed system, a partitioning scheme comprising time partitions and location partitions as a function of time information and location information pertaining to the subset of the georeferenced vehicle data;
training, using the first computing unit of the distributed system, a machine-learning method for predicting a zoom level of the item of location information pertaining to the georeferenced vehicle data with the ascertained partitioning scheme and with the subset of the georeferenced vehicle data;
partitioning, using a plurality of computing units of the distributed system, data pertaining to the received georeferenced vehicle data using the trained machine-learning method;
storing, using the plurality of computing units of the distributed system, the partitioned data pertaining to the received georeferenced vehicle data in the data memory of the distributed system;
receiving a request message requesting georeferenced vehicle data, the request message including a request message item of time information and a request message item of location information; and
providing the georeferenced vehicle data pertaining to the request message, the georeferenced vehicle data being provided by using the stored partitioned data.

14. The method as claimed in claim 13, wherein a size of the subset of the georeferenced data is chosen in such a way that the partitioning scheme for the subset of the georeferenced data can be ascertained by the first computing unit of the distributed system.

15. The method as claimed in claim 14, wherein a size of the subset of the georeferenced data is chosen in such a way that the machine-learning method can be trained by the first computing unit of the distributed system.

16. The method as claimed in claim 15, further including:
distributing the trained machine-learning method from the first computing unit of the distributed system to the plurality of computing units of the distributed system.

17. The method as claimed in claim 13, wherein a size of the subset of the georeferenced data is chosen in such a way that the machine-learning method can be trained by the first computing unit of the distributed system.

18. The method as claimed in claim 13, wherein the subset of the georeferenced data is determined as a function of a temporal data progression; and
wherein the temporal data progression is representative of at least one of the group consisting of a day, a week, and a month.

19. The method as claimed in claim 13, wherein the subset of the georeferenced data is determined as a function of a temporal data progression; and
wherein the temporal data progression is representative of a difference between weekdays and weekend days, wherein weekdays are Monday through Friday and weekend days are Saturday and Sunday.

20. The method as claimed in claim 13, wherein the partitioning scheme is ascertained using quadtrees.

21. The method as claimed in claim 13, wherein the partitioning scheme ascertains a time partition and a location partition for an item of time information and an item of location information pertaining to a dataset of the subset of the georeferenced data.

22. The method as claimed in claim 21, wherein the partitioning, using the plurality of computing units of the distributed system, of the data pertaining to the received georeferenced vehicle data by using the trained machine-learning method comprises:
determining a time partition of the partitioning scheme as a function of an item of time information pertaining to the dataset;
predicting, using means of one computing unit of the plurality of computing units, a zoom level of a location partition as a function of an item of location information pertaining to a dataset of the received georeferenced vehicle data with the trained machine-learning method;
determining, using the computing unit of the plurality of computing units, a geohash by using the item of location information and the predicted zoom level of the location partition; and
determining a location partition of the partitioning scheme as a function of the geohash.

23. The method as claimed in claim 22, wherein the storing, using the plurality of computing units of the distributed system, of the partitioned data pertaining to the received georeferenced vehicle data in the data memory of the distributed system comprises:
storing the dataset of the received georeferenced vehicle data in the determined time partition and location partition.

24. The method as claimed in claim 21, wherein the location partition is uniquely determined using a geohash.

25. The method as claimed in claim 24, wherein the geohash specifies a zoom level of the location partition.

26. The method as claimed in claim 21, wherein the storing, using the plurality of computing units of the distributed system, of the partitioned data pertaining to the received georeferenced vehicle data in the data memory of the distributed system comprises:
storing the dataset of the received georeferenced vehicle data in a determined time partition and a determined location partition.

27. The method as claimed in claim 13, wherein the training of the machine-learning method includes ascertaining hyperparameters of the machine-learning method by means of cross-validation.

28. The method as claimed in claim 13, further including:
distributing the trained machine-learning method from the first computing unit of the distributed system to the plurality of computing units of the distributed system.

29. The method as claimed in claim 13, wherein the providing of the georeferenced vehicle data pertaining to the request message comprises:
determining one or more time partitions as a function of the item of time information pertaining to the request message;
ascertaining geohashes of zoom levels including the zoom level as a function of the item of location information pertaining to the request message;
determining location partitions of the ascertained geohashes;
interrogating the georeferenced vehicle data, the item of time information and the item of location information pertaining to the request message in the determined one or more time partitions and in the determined location partitions; and
providing the interrogated georeferenced vehicle data in response to the request message.

30. A non-transitory computer-readable medium for storing and providing georeferenced vehicle data, the computer-readable medium including instructions that, when executed in one or more computing units of a distributed system, execute the method as claimed in claim 13.

31. A distributed system for storing and providing georeferenced vehicle data, the distributed system being configured to execute the method as claimed in claim 13.
